(19) United States
(12) Patent Application Publication
(10) Pub. No.: US 2017/0200383 A1
(43) Pub. Date: Jul. 13, 2017

(54) AUTOMATED REVIEW OF FORMS THROUGH AUGMENTED REALITY

(71) Applicant: INVENCIONES TECNOLÓGICAS SPA, Las Condes, Santiago (CL)

(72) Inventors: Cristián Andrés ROMERO ORELLANA, Las Condes, Santiago (CL); Edmundo Gastón CASAS CÁRDENAS, Las Condes, Santiago (CL)

(21) Appl. No.: 15/314,035

(22) PCT Filed: May 27, 2014
(86) PCT No.: PCT/IB2014/061761

§ 371 Date: Nov. 25, 2016

(51) Int. Cl. G09B 7/10; G06K 9/20; G06K 9/62; G06K 9/00

(52) U.S. Cl. CPC G09B 7/10; G06K 9/00671; G06K 9/2063; G06K 9/6202

(57) ABSTRACT

The present invention discloses a system and method for automatic review of forms with filled boxes in a sheet and digital processing of the image using augmented reality patterns, a form with binary codes on the edges of a printed template on each sheet, an optical device to read binary codes and a central processing unit for processing data from the binary codes. The form includes binary boxes on the edges of a printed template on each sheet. Binary codes along the edges of each pattern allow different templates simultaneously and automatically determine the sheet position with respect to the optical device. Pixel positions are read from user filled boxes to indicate options of the printed template in paper. Metrics are provided relevant to the assessment of each template as alternatives marked, scores obtained, grades and statistics associated with the results of the filling of boxes.

### APPLICATION FIELD OF THE INVENTION

This invention consists in a method and a system to automatically review forms by the digital processing of images using the technique of augmented reality. The invention is mainly associated with detecting answers in forms comprising at least two alternatives.

### DESCRIPTION OF THE PRIOR ART

In the current state of the art there are several systems and methods that use the augmented reality technology for the digital processing of images or texts.

Document US 2010/111405, Lee Su Woong et al, describes a method to recognize printed markers in learning material, including the sampling of an image of the learning material; the grouping of pixels of the sampled image in a first group of images and a second group of images based on a threshold level; and the calculation of medians of the first image of the group and the second group of images to update the threshold with a first mean value of the calculated medians. In addition, the method for the recognition of printed markers in the learning material includes repeating the previous stages until the difference between the prior threshold and the updated threshold is equal to or lower than a reference value; finally, an image caught by a camera is binarized on the basis of the updated threshold and the detection of markers on the basis of the binary image.

In addition, document KR20100089241 (A), Lee Won Woo, describes a method to produce and recognize a marker though augmented reality, including several types of context information for the provision of the augmented reality to a marker. With the method described, context information is obtained in relation to a marker by decoding a binary code. Should the image of a figure be included in the marker, the figure of the image is recognized. Should the text image be included in the marker, the text of the image is recognized through a character recognition algorithm by an OCR (optical character reader). The marker includes a binary pattern, an insertion portion of images and a limit portion of area.

Document KR20110134574 (A), Tai Jai Hoon, describes an augmented reality system through an input and output of an image device and a system-associated method, consisting in providing an image matching the tip of a user's finger in an image menu by overlapping a photographed image with the image menu and providing the image through laser scanning. The device comprises an AR (Augmented Reality) terminal that overlaps a RGB (Red, Green and Blue) image in an image signal in parallel with a preset image of the menu. The AR terminal scans an AR laser signal to an optical lens. The AR terminal generates an AR image, so that an AR operation server can receive the image from the AR terminal and transmits the moving images stored in the AR terminal.

The application for international patent WO2013112738 (A1), Baheti, describes an electronic device and a method used in a camera to capture an image or a video frame from an environment outside the electronic device, followed by the identification of blocks of regions in the image. Each block containing a region is reviewed to see it if passes a test to detect the presence of a line of pixels. When the test is passed for a block, this block is marked as pixel-line-present. One or several blocks next to the block of pixels of the current line can be merged with it when one or more rules meet, thus resulting in a combined or merged block. The merged block is subject to the test described above in order to check the presence of a line of pixels.

Document WO2008112216 (A1), Richard Long, describes a method consisting in responding to a determination for a two-dimension readable machine code may be identified in a first image. Said first image comprises a first plurality of pixels defining said code and a second plurality of pixels defining a non-code zone, thus automatically allowing saving or viewing a second image comprising said bi-dimensional code readable by a machine or a representation of said bi-dimensional machine readable code and excluding said non-code zone.

Although in the state of the art the use of augmented reality to determine certain specific patterns is described, not one of the technologies described above allows determining the point in the coordinates accurately, which are taken as patterns. In addition, they do not allow multiple monitoring inside the frames defined and they do not work with internal patterns.

### SUMMARY OF THE INVENTION

The present invention describes a method and a system for the automated review of forms using binary markers, augmented reality techniques and digital processing of images in order to identify in real time the options marked by a person on a sheet with a printed template. This template offers several boxes to be filled with a pen and to indicate the answers with at least one type of alternative, true and false, matching terms or another system of answers with finite and enumerable alternatives.

The system is made up by a template with binary markers (for example a printed sheet of paper), an optical device to read said template in real time (for example a web camera or a Smartphone or tablet camera) and a processor (for example, of a computer, Smartphone or tablet).

The system allows the optical device to viewing the template, identifying the position of each box and determining which boxes are full and which ones empty. The identification process for the position and filling is made by the processor, which obtains—automatically and in real time—the options marked in the template's boxes, so that to determine, for example, the answers in a test or the preferences of a user in a survey.

Since augmented reality techniques are used, the system is tolerant to user's errors when placing the template in front of the optical device, because the augmented reality system determines the location and orientation of each marker, without the user needing to present the template in an exact position and orientation.

In addition, the system allows to detecting multiple patterns simultaneously, being limited only by the resolution of the optical device used.

### BRIEF DESCRIPTION OF FIGURES

FIG. 1 shows a scheme of the system and method under a preferred embodiment of the invention.

FIG. 2 shows a frame with a binary marker inside under a preferred embodiment of the invention.

FIG. 3 shows a binary marker with a module of alternatives under a preferred embodiment of the invention.

FIG. 4 shows a virtual detector in the 3D space under a preferred embodiment of the invention.

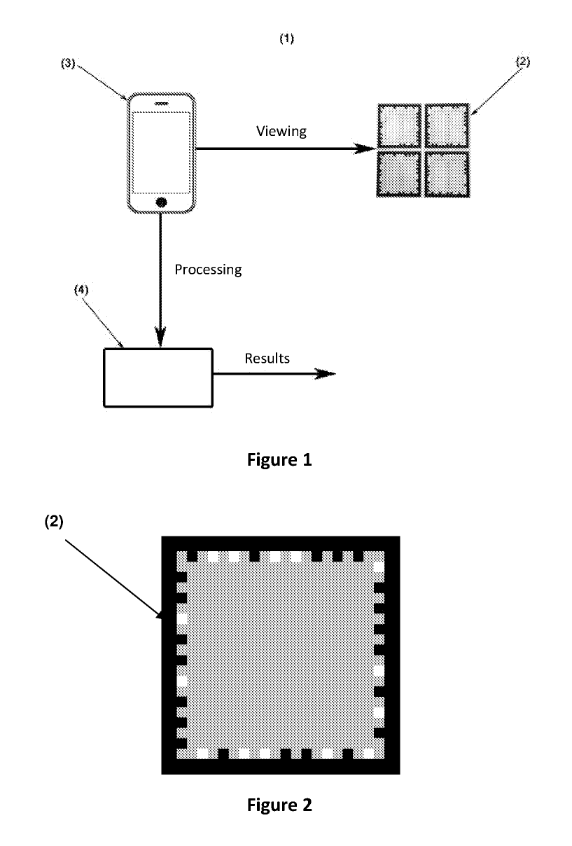

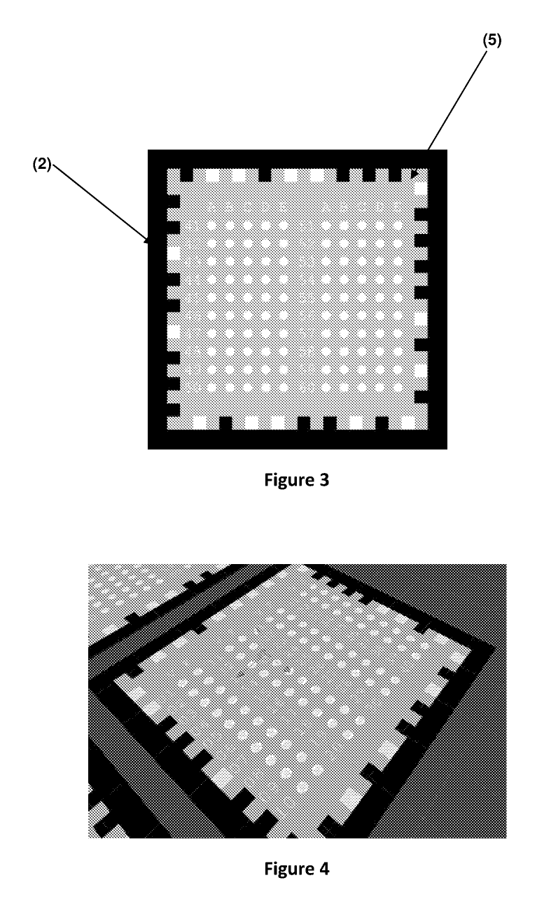

### DETAILED DESCRIPTION OF THE INVENTION

The present invention describes a method and a system for the automated review of forms: Said system and method use binary markers, together with augmented reality techniques and digital processing of images in order to identify in real time the options marked by a person on a sheet with a printed template that offers several boxes to be filled with a pen and to indicate the answers of the type of alternative, true and false, matching terms or another system of answers with finite and enumerable alternatives.

The system (1) comprises a template with binary markers (2), an optical device (3) that reads said template (2) in real time and a processor (4). The binary markers of each template (2) define at least one box (5) viewed in said template (2).

The system allows that the optical device (3), when viewing the template (2), identifies the position of each box (5) and determines which boxes (5) are full and which ones empty. The identification process for the position and filling is made by the processor (4), which obtains—automatically and in real time—the options marked in the boxes (5) of the template (2), so that to determine, for example, the answers to said form and, in particular the answers to a test or the preferences of a user in a survey.

Since augmented reality techniques are used, the system (1) is tolerant to user's errors when placing the template (2) in front of the optical device (3), because the augmented reality system (1) determines the location and orientation of each marker, without the user needing to present the template (2) in an exact position and orientation.

In addition, the system (1) allows to detecting multiple patterns simultaneously, being limited only by the resolution of the optical device (3) used.

The process of the automated review of forms comprises the installation of a multi-platform software in the processor (4) allowing to identifying the date entered into a template (2) with boxes to be filled by the user. When the program is executed, it shows the information captured by the optical device (3) in real time. When presenting the template (2) in front of the optical device (3), the software identifies which boxes (5) were marked by the user and, later, data are collected, the information collected is shown and sent by a network to be processed according to the nature of the data obtained.

The program allows synchronizing the detectors of boxes in the virtual 3D space with the boxes located in the 2D space of the template.

For the user, the process is similar to reading the bar codes, because when showing the template (2) in front of the optical device (3) and reading the data of boxes immediately, a warning signal is generated indicating that the data have been obtained. Unlike the bar codes, reading in this case is of marked boxes, this being why the processing required to obtaining these data is much more complex.

The system (1) uses a frame to identify the possible areas where a binary marker can be found and to recover the orientation and location of the frame with respect to the optical device.

Inside the frame there is a binary marker allowing to determining the location of each box (5) available to be filled. Due to the nature of binary markers, each marker is associated with a binary number. The number of binary markers available depends on the number of bits used in the marker. This number is limited by the resolution of the optical device (3) to be used when reading the template.

Once the frame and the binary marker are identified by the optical device (3), it is possible to recover its position and orientation in the 3D space related to the camera. Both the position and the orientation are mathematically represented by a M 4×4 matrix as follows:

$$M = [ \begin{matrix}R & t \\ {0}^{T} & 1\end{matrix} ]$$

Where T is the translation vector containing the location in the 3D space related to the optical device (3) and R is the 3×3 orientation matrix containing the rotation around the 3 spatial axes in the 3D space related to the camera and has the following form:

$$R = [ \begin{matrix}{R}_{11} & {R}_{12} & {R}_{13} \\ {R}_{21} & {R}_{22} & {R}_{23} \\ {R}_{31} & {R}_{32} & {R}_{33}\end{matrix} ]$$

Inside the binary marker there is a module associated with the marker's binary number containing boxes to be filled by the user, for instance with a pen. The system (1) allows having N configurations of boxes, where N is equal to the quantity of binary numbers possible to be generated with the quantity of bits used in the binary marker.

Each module printed in the template in a 2D space has its virtual equivalent in the 3D space, where there is a virtual detector of boxes in the 3D space by each box the user is able to fill in the template.

For the position of the boxes in the template's 2D position to be identified, transformation from the 3D space of virtual markers to 2D space in the template is necessary. Transformations in the 3D space are equal to multiplications of the position vector by the M matrixes previously detailed.

Each position of the detector in the 3D space is multiplied by the marker's orientation matrixes and the optical device (3). This allows bringing the detector from the 3D space to the space related to the optical device (3). Then, the detector's position vector in the space related to the optical device (3) is projected to the 2D space of the camera as follows:

X_{2D}=X_{3D}*f/Z_{3D}+X_{c}

Y_{2D}=Y_{3D}*f/Z_{3D}+Y_{c}

Where X_{3D}, Y_{3D} and Z_{3D} is the position vector in the 3D space related to the optical device (3), X_{2D} and Y_{2D} are the coordinates obtained in the 2D space of the optical device (3) in pixels, f is the focal factor of the optical device (3) used and X_{c} and Y_{c} are the central coordinates in pixels in the 2D space of the optical device (3) and depend on the resolution of the optical device (3) used.

Once the position of each box inside the binary marker has been identified, pixels are read and binarized according to a luminance threshold. Pixels exceeding the threshold are considered white and those being below the threshold are considered black. Thus, differentiating which boxes were filled by the user and which were left blank is possible.

1. A system for the automatic review of forms based on filling boxes in at least one sheet and the digital processing of the image using augmented reality patterns WHEREIN it comprises at least one form with a plurality of binary codes on the edges of at least one printed template on each sheet, at least one optical device to read said binary codes and one central processing unit for the processing of data obtained from the binary codes from at least the optical device.

2. A system for the automatic review of forms based on filling boxes in a sheet and the digital processing of the image, or similar, according to claim 1 WHEREIN the at least one optical device is comprised in the group of one webcam, Smartphone camera, digital camera or scanner.

3. A system for the automatic review of forms based on filling boxes in a sheet and the digital processing of the image, or similar, according to claim 1 WHEREIN the central processing unit comprises the group of Smartphone, tablets and computers.

4. A system for the automatic review of forms based on filling boxes in a sheet and the digital processing of the image, or similar, according to claim 1 WHEREIN the binary codes are arranged around patterns of augmented reality that differentiate between one pattern and another one from a set of N patterns, where N is the quantity of numbers that can be represented with the quantity of bits of the binary code.

5. A system for the automatic review of forms based on filling boxes in a sheet and the digital processing of the image, or similar, according to claim 4 WHEREIN the boxes to be filled in each one of N templates are uniformly spaces and arranged in a color other than the filling of boxes color, so that to be distinguished by the human eye and the optical device.

6. A method for the automatic review of forms based on filling boxes in at least one sheet and the digital processing of the image using patterns of augmented reality WHEREIN it uses an automatic review system comprising the steps of:
providing at least one form with a plurality of binary boxes on the edges of at least one printed template on each sheet,
providing at least one optical device for the reading of said binary codes and one central processing units for the processing of data obtained from the binary codes from at least the optical device;
providing binary codes on the edges of each augmented reality pattern to allow different templates at the same time;
automatically determining the position of the sheet with respect to the optical device observing it;
specifically reading the positions of pixels where the user has filled the boxes to indicate one or more options of the printed template in paper;
collecting data through the central processing unit that provides the metrics relevant to the assessment of each template as alternatives marked, scores obtained, grades and statistics associated with the results of the filling of boxes.

7. A method for the automatic review of forms based on filling boxes in at least one sheet and the digital processing of the image using patterns of augmented reality according to claim 6, WHEREIN it also comprises the step of:
providing the use of augmented reality patterns to determine the position with respect to the optical device of each printed template on a sheet.

8. A method for the automatic review of forms based on filling boxes in at least one sheet and the digital processing of the image using patterns of augmented reality according to claim 6, WHEREIN it also comprises the step of:
reading the pixels of each box inside the augmented reality pattern, which can be filled or not by the user and are associated with a template of answers, of the multiple choice type of one or more alternatives;
automatically comparing the boxes filled by the user with the template detected and associated with the binary code on the edge of the augmented reality template;
determining a score associated with the boxes filled automatically.
